(19) United States
(12) Patent Application Publication
(10) Pub. No.: US 2007/0297096 A1
(43) Pub. Date: Dec. 27, 2007

(54) Magnetic head

(75) Inventors: Tomoka Aoki, Kawasaki (JP); Ryuei Ono, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/544,077

(22) Filed: Oct. 5, 2006

(30) Foreign Application Priority Data
Jun. 27, 2006 (JP) 2006-176983

(51) Int. Cl. G11B 5/33; G11B 5/127

(52) U.S. Cl. 360/319

(57) ABSTRACT

In the magnetic head, characteristics of a read-element is not badly influenced by external electromagnetic waves, and the magnetic head is highly resistant to external electromagnetic waves. The magnetic head comprises: a write-head; a read-head having a read-element, which is grounded to a substrate via a resistance; and an electromagnetic wave shielding layer covering over a resistance area, in which the resistance is formed.

### BACKGROUND OF THE INVENTION

The present invention relates to a magnetic head, more precisely relates to a magnetic head, which is highly resistant to external electromagnetic waves.

A read-element of a magnetic head is apt to be damaged by static electricity, so the read-element is protected from static electricity in a process of producing the magnetic head. An outline of a measure against static electricity (an antistatic method) for a GMR (Giant Magneto Resistance) type read-element 5 is shown in FIG. 12A; an outline of a measure against static electricity for a TMR (Tunneling Magneto Resistance) type read-element 6 is shown in FIG. 12B. In case of the GMR type read-element 5, terminals 5a and 5b are electrically connected to a lower shield 7 and an upper shield 8, and the shields 7 and 8 are grounded to a substrate 4 via a resistance 10. On the other hand, in case of the TMR type read-element 6, a lower shield 7 and an upper shield 8 are grounded to a substrate 4 via the resistance 10. In each of the drawings, a lower magnetic pole 9 of a write-element is provided on the upper side of the read-element 5 or 6.

FIG. 11A is a view of the GMR type magnetic head seen from the terminal side, and FIG. 11B is a sectional view taken along a line A-A shown in FIG. 11A. In FIG. 11A, a read-head is formed under a write-head 18.

Electrodes 5a and 5b, which are extended from the read-element 5, are connected to terminals 12a and 12b via an upper shield 8, the lower magnetic pole 9 and cables 11a and 11b, so that the read-head is connected to the terminals 12a and 12b. In the write-head 18, a coil 19 for recording data is connected to terminals 15a and 15b via cables 14a and 14b.

The resistance 10 against static electricity is formed on rear faces of the lower shield 7 and the upper shield 8. Namely, the resistance 10 is formed on the upper side faces of the shields 7 and 8 in the height direction of the magnetic head. The resistance 10 has a high resistance value so as not to badly influence characteristics of the read-element. As shown in FIG. 11A, the resistance 10 is meandered so as to elongate and gain required resistance values.

By the way, in the TMR type magnetic head, we have found that characteristics of the read-element are badly influenced by external electromagnetic waves in a specific frequency band.

As described above, the resistance is added to the element so as to protect the magnetic head from static electricity. The resistance is a metallic thin film made of, for example, tantalum, and it must have a length of several hundred μm. To form the resistance having the prescribed length in a limited space, the resistance 10 is branched rightward and leftward from a connecting point, at which the resistance is connected to the substrate, and meandered as shown in FIG. 11A.

By employing the meandered resistance 10, the resistance 10 generates noises when the resistance 10 receives the external electromagnetic waves, so that characteristics of the read-element are badly influenced.

Patent Document 1 Japanese Patent Gazette No. 2000-113417

Patent Document 2 Japanese Patent Gazette No. 9-63019

### SUMMARY OF THE INVENTION

The present invention was conceived to solve the problems.

An object of the present invention is to provide a magnetic head, in which characteristics of a read-element is not badly influenced by external electromagnetic waves and which is highly resistant to external electromagnetic waves.

To achieve the object, the present invention has following structures.

Namely, the magnetic head of the present invention comprises: a write-head; a read-head having a read-element, which is grounded to a substrate via a resistance; and an electromagnetic wave shielding layer covering over a resistance area, in which the resistance is formed.

In the magnetic head, the read-head may have an upper shield and a lower shield, and a shield pattern, which acts as the electromagnetic wave shielding layer, may be formed in at least one of the upper and lower shields; and the resistance may be provided between the lower shield and the substrate or between the lower shield and the upper shield in a layering direction. With these structures, the resistance can be shielded from external electromagnetic waves and generating noises can be prevented, so that reliability of the magnetic head can be improved.

In the magnetic head, the resistance may be provided between the lower shield and the substrate in a layering direction, and the electromagnetic wave shielding layer may be separated from magnetic layers constituting the read-head and the write-head and formed between the resistance and the lower shield in the layering direction; and the resistance may be provided between the lower shield and the substrate in a layering direction, and the electromagnetic wave shielding layer may be separated from magnetic layers constituting the read-head and the write-head and formed between the resistance and the substrate in the layering direction. With these structures too, the resistance can be shielded from external electromagnetic waves, and the magnetic head can be highly resistant to external electromagnetic waves.

In the magnetic head, the resistance may be provided between the lower shield and the upper shield in a layering direction, and the electromagnetic wave shielding layer may be separated from magnetic layers constituting the read-head and the write-head and formed on the upper side of the upper shield; and the resistance may be provided between the lower shield and the upper shield in a layering direction, and the electromagnetic wave shielding layer may be separated from magnetic layers constituting the read-head and the write-head and formed on the upper side of the write-head. With these structures too, the resistance can be shielded from external electromagnetic waves, and the magnetic head can be highly resistant to external electromagnetic waves.

Further, in the magnetic head, the resistance may be provided between the lower shield and the upper shield in a layering direction, and a pair of the electromagnetic wave shielding layers may be separated from magnetic layers constituting the read-head and the write-head and formed between the lower shield and the substrate and on the upper side of the upper shield; and the resistance may be provided between the lower shield and the upper shield in a layering direction, and a pair of the electromagnetic wave shielding layers may be separated from magnetic layers constituting the read-head and the write-head and formed between the lower shield and the substrate and on the upper side of the write-head. With these structures, the magnetic head can be highly resistant to external electromagnetic waves.

In the magnetic head of the present invention, the electromagnetic wave shielding layer is formed so as to cover over the resistance area, in which the resistance for protecting the read-element from static electricity is formed, so that the resistance can be shielded from external electromagnetic waves. Therefore, generating noises in the resistance can be prevented, deterioration of the read-element can be prevented, reliability of the magnetic head can be improved and characteristics of the magnetic head can be stabilized.

### BRIEF DESCRIPTION OF THE DRAWINGS

Embodiments of the present invention will now be described by way of examples and with reference to the accompanying drawings, in which:

FIG. 1A is an end view of a magnetic head of a first embodiment:

FIG. 1B is a sectional view taken along a line A-A shown in FIG. 1A;

FIG. 2A is an end view of a magnetic head of a second embodiment:

FIG. 2B is a sectional view taken along a line A-A shown in FIG. 2A;

FIG. 3A is an end view of a magnetic head of a third embodiment:

FIG. 3B is a sectional view taken along a line A-A shown in FIG. 3A;

FIG. 4A is an end view of a magnetic head of a fourth embodiment:

FIG. 4B is a sectional view taken along a line A-A shown in FIG. 4A;

FIG. 5A is an end view of a magnetic head of a fifth embodiment:

FIG. 5B is a sectional view taken along a line A-A shown in FIG. 5A;

FIG. 6A is an end view of a magnetic head of a sixth embodiment:

FIG. 6B is a sectional view taken along a line A-A shown in FIG. 6A;

FIG. 7A is an end view of a magnetic head of a seventh embodiment:

FIG. 7B is a sectional view taken along a line A-A shown in FIG. 7A;

FIG. 8A is an end view of a magnetic head of an eighth embodiment:

FIG. 8B is a sectional view taken along a line A-A shown in FIG. 8A;

FIG. 9A is an end view of a magnetic head of a ninth embodiment:

FIG. 9B is a sectional view taken along a line A-A shown in FIG. 9A;

FIG. 10A is an end view of a magnetic head of a tenth embodiment:

FIG. 10B is a sectional view taken along a line A-A shown in FIG. 10A;

FIG. 11A is an end view of the conventional magnetic head:

FIG. 11B is a sectional view taken along a line A-A shown in FIG. 11A;

FIGS. 12A and 12B are explanation views of the antistatic method;

FIG. 13 is a perspective view of the head slider; and

FIG. 14 is a plan view of the conventional magnetic disk drive unit.

### DETAILED DESCRIPTION OF THE EMBODIMENTS

Preferred embodiments of the present invention will now be described in detail with reference to the accompanying drawings.

### First Embodiment

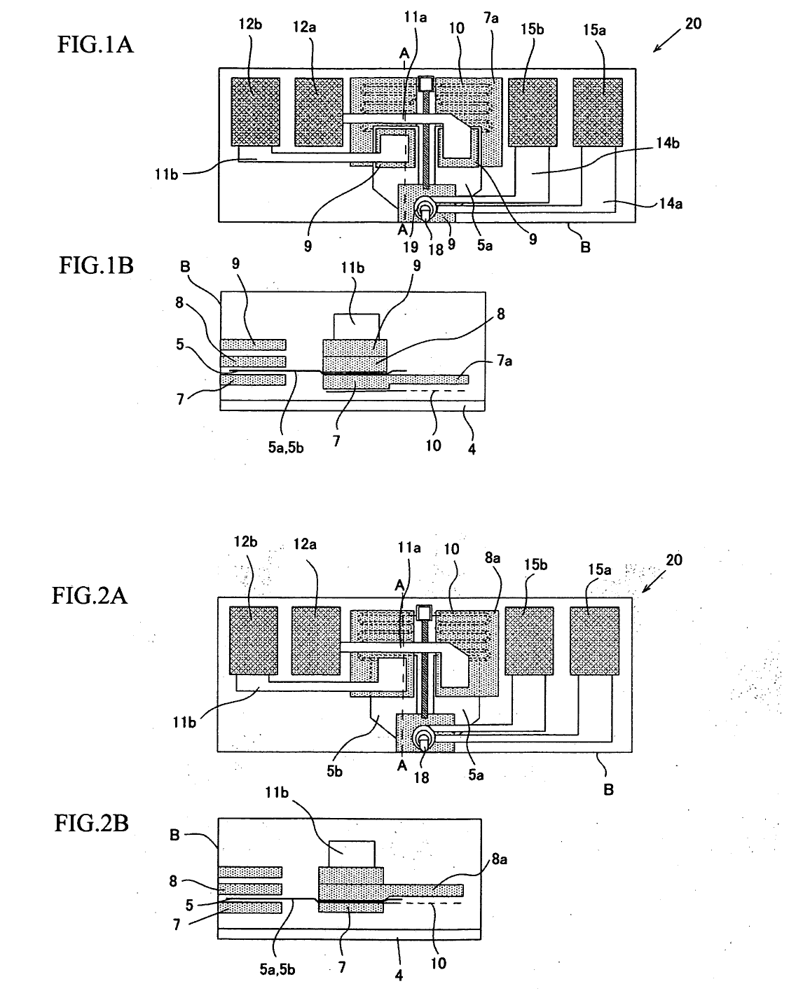

A magnetic head of a first embodiment is shown in FIGS. 1A and 1B. FIG. 1A is an end view of the magnetic head, and FIG. 1B is a sectional view taken along a line A-A shown in FIG. 1A. Note that, other embodiments are also explained with reference to end views of the magnetic heads and sectional views taken along lines A-A.

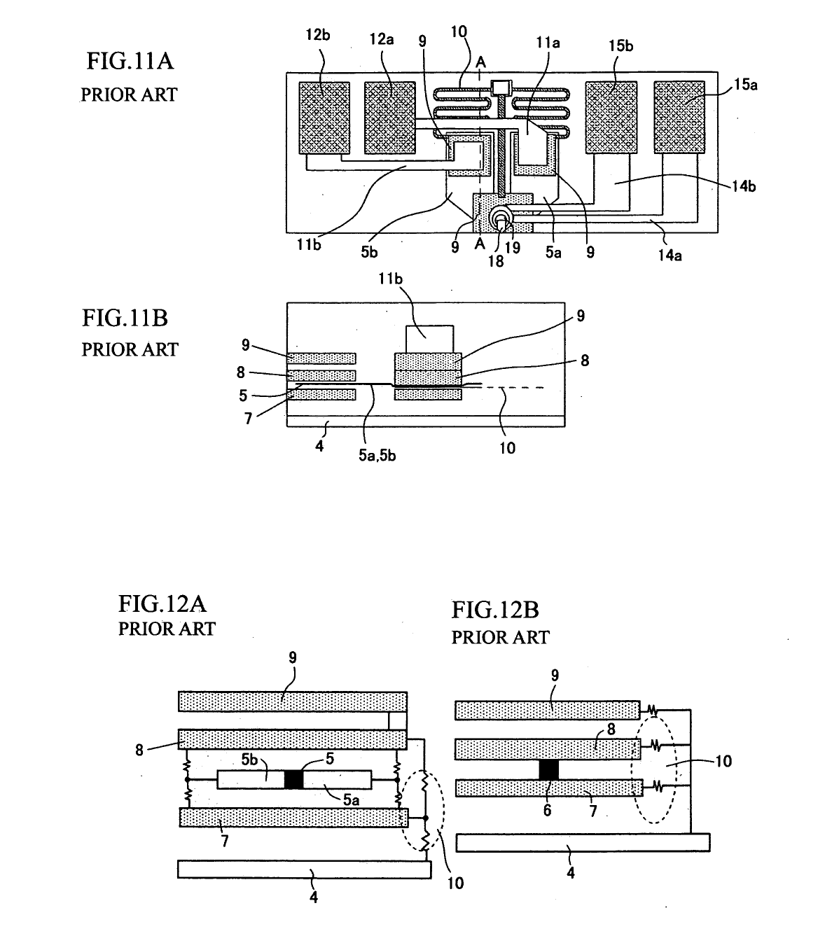

In the first embodiment, the magnetic head 20 is a GMT type magnetic head, and its basic structure is the same as that of the conventional magnetic head shown in FIGS. 11A and 11B. Namely, a read-element 5 of a read-head is sandwiched between a lower shield 7 and an upper shield 8. Electrodes 5a and 5b are connected to side faces of the read-element 5, and the electrodes 5a and 5b are extended toward a rear side and respectively connected to terminals 12a and 12b via cable wires 11a and 11b. Note that, in FIGS. 1A and 1B, a surface “B” is an air bearing surface. Note that, in the specification, the word “rear side” means an upper side in the height direction or a side opposite to a surface of a recording medium with respect to the surface “B”.

A write-head 18 includes a lower magnetic pole 9 and a coil 19 for writing data. The coil 19 is connected to terminals 15a and 15b via cable wires 14a and 14b.

As shown in FIG. 1B, a resistance 10 against static electricity is formed between a substrate 4, which is made of Al₂O₃-TiO, and the lower shield 7 in the layering direction and in an upper part (a rear part) in the height direction. One end of the resistance 10 is connected to the lower shield 7, and the other end thereof is grounded to the substrate 4.

The first embodiment is characterized in that the lower shield 7 is extended in the height direction and the width direction so as to cover a resistance area (a planar area), in which the resistance 10 is formed, with a shield pattern 7a.

The resistance 10 has a prescribed resistance value and made of a metallic material, e.g., tantalum, by sputtering. A resist pattern is formed on the substrate 4 so as to form the meandered resistance, then the metallic material, e.g., tantalum, is sputtered so as to form the meandered resistance 10 having the prescribed resistance value. The lower shield 7, the upper shield 8 and the lower magnetic pole 9 are grounded to the substrate 4 via the resistance 10, so that the read-element 5 can be protected from static electricity.

As shown in FIGS. 1A and 1B, the resistance area, in which the resistance 10 is formed, is covered with the shield pattern 7a. Therefore, even if external electromagnetic waves work to the magnetic head 20, the resistance 10 can be shielded from the electromagnetic waves by the shield pattern 7a so that the read-element 5 can be protected from the electromagnetic waves.

The lower shield 7 is made of a magnetic material, e.g., NiFe, and formed by electrolytic plating. When the lower shield 7 is pattern-formed, the lower shield 7 having the shield pattern 7a is formed so as to integrate the shield pattern 7a with the lower shield 7. In other words, the lower shield 7 having the shield pattern 7a which acts as an electromagnetic wave shielding layer is formed. Of course, the entire lower shield 7 including the shield pattern 7a shields external electromagnetic waves.

### Second Embodiment

The magnetic head of a second embodiment is shown in FIGS. 2A and 2B. The basic structure of the magnetic head of the second embodiment is the same as that of the first embodiment. Note that, structural elements explained in the first embodiment are assigned to the same symbols and explanation will be omitted.

The second embodiment is characterized in that the upper shield 8 is extended in the height direction and the width direction so as to cover the resistance area, in which the resistance 10 is formed, with a shield pattern 8a, which acts as an electromagnetic waves shielding layer.

The resistance 10 is formed between the lower shield 7 and the upper shield 8, and the resistance 10 in the height direction is meandered in an upper part of the area. The lower shield 7, the upper shield 8 and the lower magnetic pole 9 are electrically connected and grounded to the substrate 4 via the resistance 10, so that the read-element 5 can be protected from static electricity.

Since the upper shield 8 has the shield pattern 8a which covers over the resistance area including the resistance 10, external electromagnetic waves working to the magnetic head 20 can be shielded by the shield pattern 8a. Therefore, noises in the resistance 10, which are generated by the external electromagnetic waves, can be prevented, and the read-element 5 can be protected from the external electromagnetic waves.

The upper shield 8 is a magnetic film made of, for example, NiFe and has a prescribed thickness. The upper shield 8 may be formed by, for example, electrolytic plating. The shield pattern 8a may be simultaneously patterned in a process of forming the upper shield 8.

### Third Embodiment

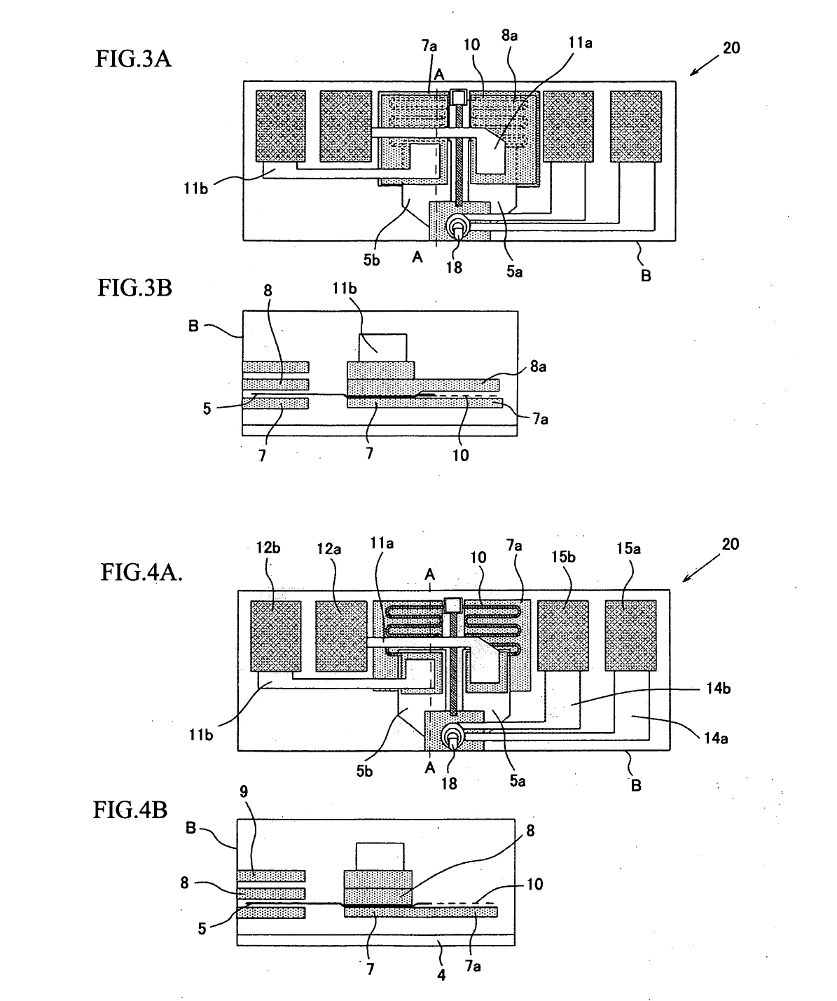

The magnetic head of a third embodiment is shown in FIGS. 3A and 3B. The basic structure of the magnetic head of the third embodiment is the same as that of the former embodiments. Note that, structural elements explained in the former embodiments are assigned to the same symbols and explanation will be omitted.

The third embodiment is characterized in that the lower shield 7 and the upper shield 8 are extended in the height direction and the width direction so as to cover the resistance area, in which the resistance 10 is formed, with both of the shield pattern 7a and the shield pattern 8a.

The resistance 10 is formed between the lower shield 7 and the upper shield 8 in the layering direction, and the resistance 10 is meandered, as well as the second embodiment.

In the third embodiment, the resistance 10 sandwiched between the shield pattern 7a of the lower shield 7 and the shield pattern 8a of the upper shield 8. With this structure, external electromagnetic waves working to the magnetic head 20 can be shielded on the both sides of the resistance 10, so that resistance property of the magnetic head of the third embodiment can be improved more than those of the former embodiments.

The shield patterns 7a and 8a may be simultaneously formed, by electrolytic plating, etc., in processes of forming the lower shield 7 and the upper shield 8. Therefore, the conventional processes for forming the lower shield 7 and the upper shield 8 can be used without changing steps.

### Fourth Embodiment

The magnetic head of a fourth embodiment is shown in FIGS. 4A and 4B. The basic structure of the magnetic head of the fourth embodiment is the same as that of the former embodiments. Note that, structural elements explained in the former embodiments are assigned to the same symbols and explanation will be omitted.

The fourth embodiment is characterized in that the shield pattern 7a is formed in the lower shield 7 as well as the first embodiment. In the first embodiment, the resistance 10 is formed between the substrate 4 and the lower shield 7 in the layering direction. On the other hand, in the third embodiment, the resistance 10 is formed between the lower shield 7 and the upper shield 8.

Since the resistance 10 is formed in a process of forming films on the substrate 4, the resistance 10 may be formed between the substrate 4 and the lower shield 7 or between the lower shield 7 and the upper shield 8.

In the present embodiment too, the shield pattern 7a of the lower shield 7 covers over the resistance 10. Therefore, the resistance 10 can be shielded from external electromagnetic waves working to the magnetic head 20, generating noises in the resistance 10 can be prevented and deterioration of the read-element 5 can be prevented.

### Fifth Embodiment

The magnetic head of a fifth embodiment is shown in FIGS. 5A and 5B. FIG. 5A is an end view of the magnetic head, and FIG. 5B is a sectional view taken along a line A-A shown in FIG. 5A.

The fifth embodiment is characterized in that an electromagnetic wave shielding layer 16, which is separately formed from the lower shield 7, is formed on the lower side of the lower shield 7 (located close to the air bearing surface “B”).

Structures of the read-head and the write-head are the same as those of the former embodiments. As shown in FIG. 5B, one end of the resistance 10 against static electricity is connected to the lower shield 7, and the other end is grounded to the substrate 4. The lower shield 7, the upper shield 8 and the lower magnetic pole 9 are electrically connected for an antistatic method, as well as the former embodiments.

The electromagnetic wave shielding layer 16 is formed between the resistance 10 and the lower shield 7, in the layering direction, on the substrate 4. Since the electromagnetic wave shielding layer 16 is separately formed from the lower shield 7, the electromagnetic wave shielding layer 16 may be extended beyond the resistance 10 until reaching the air bearing surface “B”. In FIGS. 5A and 5B, the electromagnetic wave shielding layer 16 covers over the resistance 10 and is extended near the air bearing surface “B”. The electromagnetic wave shielding layer 16 must not be electrically shorted to the lower shield 7.

A material of the electromagnetic wave shielding layer 16 is not limited to a magnetic material. It may be made of any materials, which are capable of shielding electromagnetic waves. The electromagnetic wave shielding layer 16 may be formed on the substrate 4 by a film forming process, e.g., plating, sputtering.

In the magnetic head 20 of the present embodiment, the electromagnetic wave shielding layer 16 covers over at least the resistance area, in which the resistance 10 is formed. With this structure, external electromagnetic waves working to the resistance 10 can be shielded, and deterioration of characteristics of the read-element 5, which is caused by the external electromagnetic waves, can be prevented.

By covering the broad area, in which the read-head is formed and the resistance 10 is included, with the electromagnetic wave shielding layer 16, the entire magnetic head 20 can be shielded from external electromagnetic waves.

### Sixth Embodiment

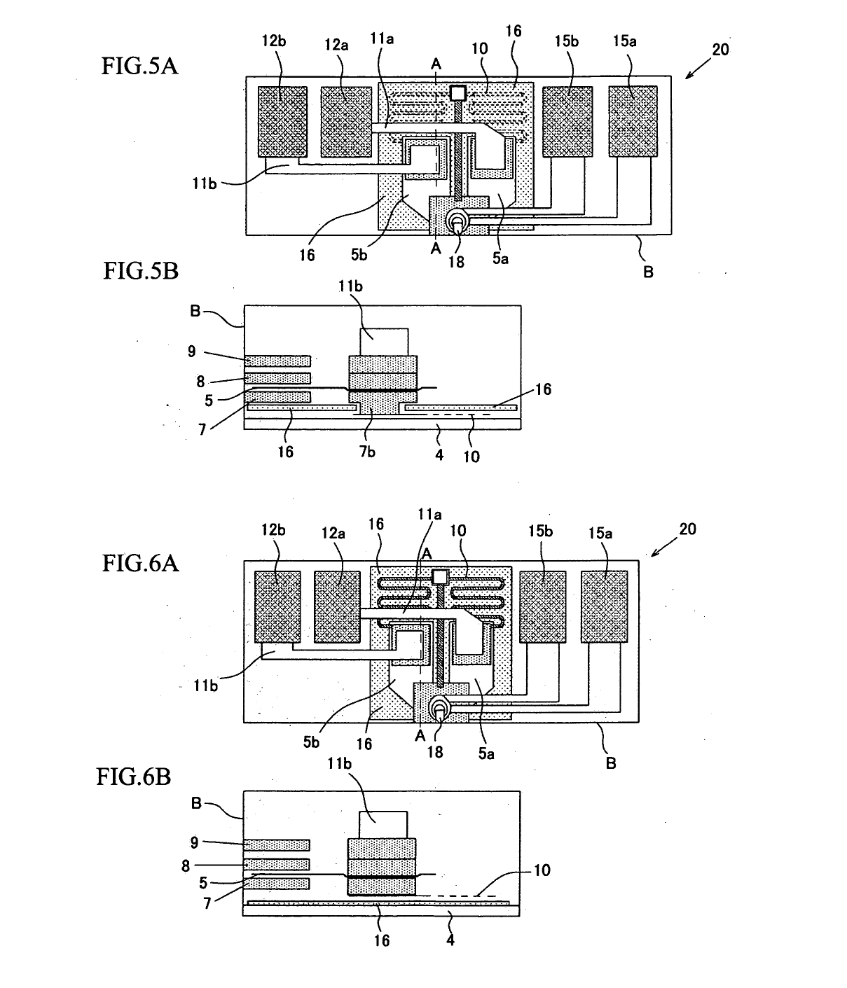

The magnetic head of a sixth embodiment is shown in FIGS. 6A and 6B. The basic structure of the magnetic head of the sixth embodiment is the same as that of the former embodiments. Note that, structural elements explained in the former embodiments are assigned to the same symbols and explanation will be omitted.

The sixth embodiment is characterized in that the electromagnetic wave shielding layer 16 is formed under the lower shield 7 as well as the fifth embodiment. In the fifth embodiment, the electromagnetic wave shielding layer 16 is formed between the resistance 10 and the lower shield 7 in the layering direction; in the sixth embodiment, the electromagnetic wave shielding layer 16 is formed between the substrate 4 and the resistance 10.

The electromagnetic wave shielding layer 16 covers over the resistance area, in which the resistance 10 is formed, and is extended near the air bearing surface “B”, as well as the fifth embodiment.

In the present embodiment too, the resistance 10 is shielded from external electromagnetic waves by the electromagnetic wave shielding layer 16, so that the read-element 5 can be protected from the external electromagnetic waves.

### Seventh Embodiment

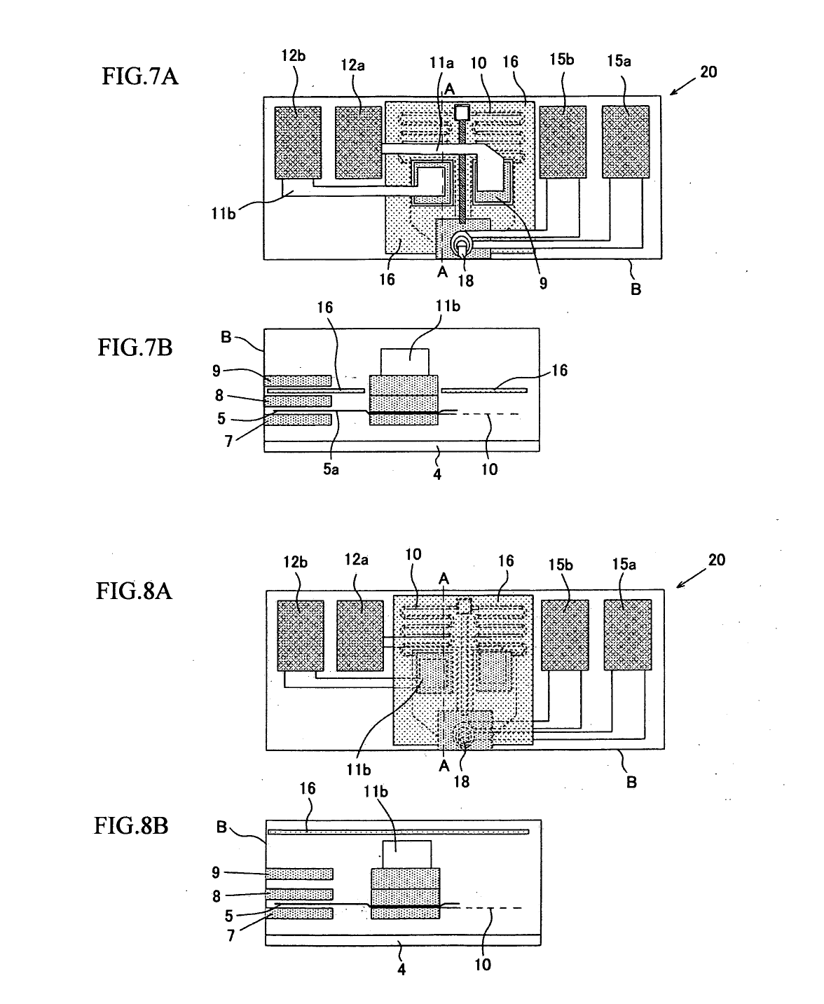

The magnetic head of a seventh embodiment is shown in FIGS. 7A and 7B. The basic structure of the magnetic head of the seventh embodiment is the same as that of the former embodiments. Note that, structural elements explained in the former embodiments are assigned to the same symbols and explanation will be omitted.

The seventh embodiment is characterized in that the electromagnetic wave shielding layer 16 is formed between the upper shield 8 and the lower magnetic pole 9 as shown in FIG. 7B. The resistance 10 against static electricity is sandwiched between the lower shield 7 and the upper shield 8 on the upper side faces of the shields 7 and 8. The lower shield 7, the upper shield 8 and the lower magnetic pole 9 are grounded to the substrate 4 via the resistance 10. Note that, an arrangement of the resistance 10 is the same as that of the conventional arrangement shown in FIGS. 11A and 11B.

As shown in FIG. 7A, the electromagnetic wave shielding layer 16 is formed to cover and shield the resistance area, in which the resistance 10 is formed, and extended near the air bearing surface “B”. Therefore, the resistance 10 can be shielded from external electromagnetic waves, and the read-head can be protected from the external electromagnetic waves.

### Eighth Embodiment

The magnetic head of an eighth embodiment is shown in FIGS. 8A and 8B. The basic structure of the magnetic head of the eighth embodiment is the same as that of the former embodiments. Note that, structural elements explained in the former embodiments are assigned to the same symbols and explanation will be omitted.

The eighth embodiment is characterized in that the electromagnetic wave shielding layer 16 is formed above a write-head in the layering direction as shown in FIG. 8B. The resistance 10 against static electricity is formed as well as the seventh embodiment.

As shown in FIG. 8A, the electromagnetic wave shielding layer 16 covers over the resistance area, in which the resistance 10 is formed, so as to shield the resistance area. Further, the electromagnetic wave shielding layer 16 is extended near the air bearing surface “B” so as to shield.

With this structure, the electromagnetic wave shielding layer 16 is capable of shielding and protecting not only the resistance 10 but also the read-head and the write-head of the magnetic head 20 from external electromagnetic waves.

### Ninth Embodiment

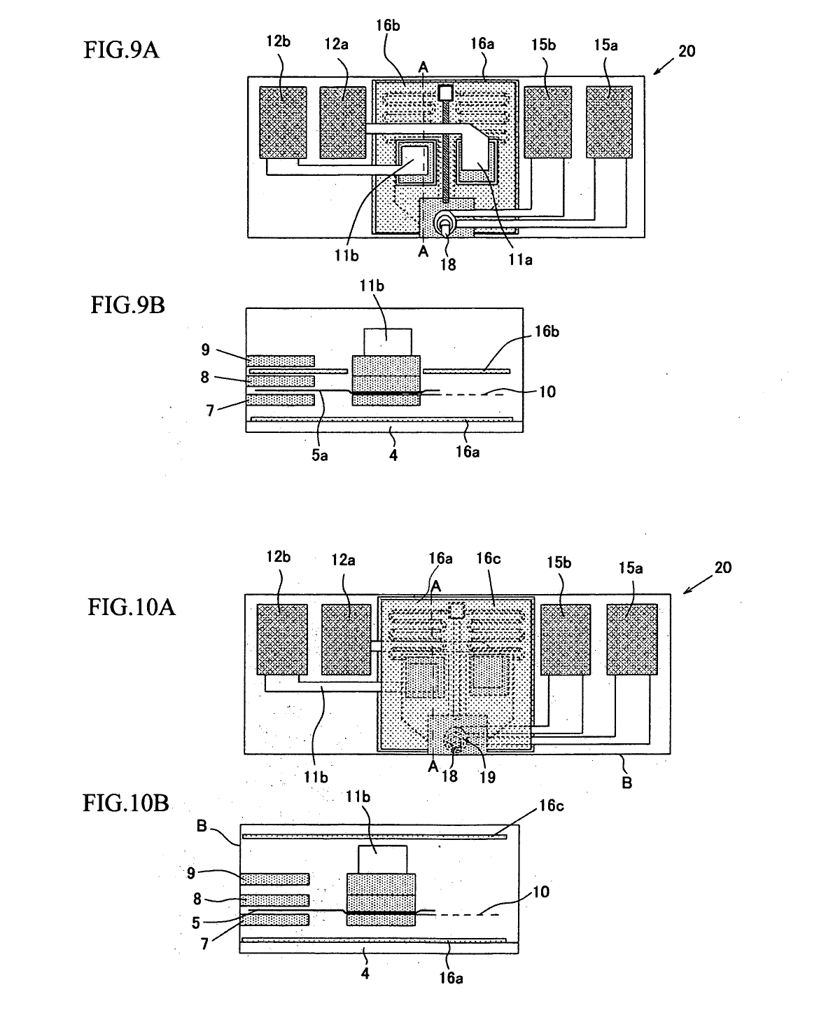

The magnetic head of a ninth embodiment is shown in FIGS. 9A and 9B. The basic structure of the magnetic head of the ninth embodiment is the same as that of the former embodiments. Note that, structural elements explained in the former embodiments are assigned to the same symbols and explanation will be omitted.

The ninth embodiment is characterized in that the electromagnetic wave shielding layers 16a and 16b are respectively formed between the substrate 4 and the lower shield 7 and between the upper shield 8 and the lower magnetic pole 9 in the layering direction. Namely, the electromagnetic wave shielding layers 16 of the sixth embodiment and the seventh embodiment are combined. The resistance 10 against static electricity is formed as well as the eighth embodiment.

In the present embodiment, the resistance 10 is sandwiched between the electromagnetic wave shielding layers 16a and 16b. In comparison with the magnetic head having the single shielding layer 16, the function of shielding the resistance 10 and the read-head from external electromagnetic waves can be further improved.

### Tenth Embodiment

The magnetic head of a tenth embodiment is shown in FIGS. 10A and 10B. The basic structure of the magnetic head of the tenth embodiment is the same as that of the former embodiments. Note that, structural elements explained in the former embodiments are assigned to the same symbols and explanation will be omitted.

The tenth embodiment is characterized in that the electromagnetic wave shielding layers 16a and 16c are respectively formed between the substrate 4 and the lower shield 7 and above the write-head. Namely, the electromagnetic wave shielding layers 16 of the sixth embodiment and the eighth embodiment are combined. The resistance 10 against static electricity is formed as well as the ninth embodiment.

In the present embodiment, the read-head and the write-head of the magnetic head 20 are sandwiched between the electromagnetic wave shielding layers 16a and 16c in the resistance area, in which the resistance 10 is formed. In comparison with the magnetic head having the single shielding layer 16, the function of shielding the resistance 10, the read-head and the write-head from external electromagnetic waves can be further improved.

Note that, in the above described embodiments, the magnetic heads have the GMR type read-elements, but the type of the read-element is not limited. For example, the shield patterns and the electromagnetic wave shielding layers may be similarly applied to magnetic heads having TMR type read-elements so as to improve resistance properties of the magnetic heads against electromagnetic waves.

In the above described embodiments, the upper shield 8 of the read-head and the lower magnetic pole 9 of the write-head are separately formed, but the present invention may be applied to a magnetic head, in which the upper shield 8 works as not only the upper shield but also the lower magnetic pole. The magnetic head of the above described embodiments are horizontal magnetic recording heads, but the type of the write-head is not limited. The present invention may be applied to vertical magnetic recording heads as well. Further, an entire structure of the magnetic head is not limited to the above described embodiments.

### Head Slider

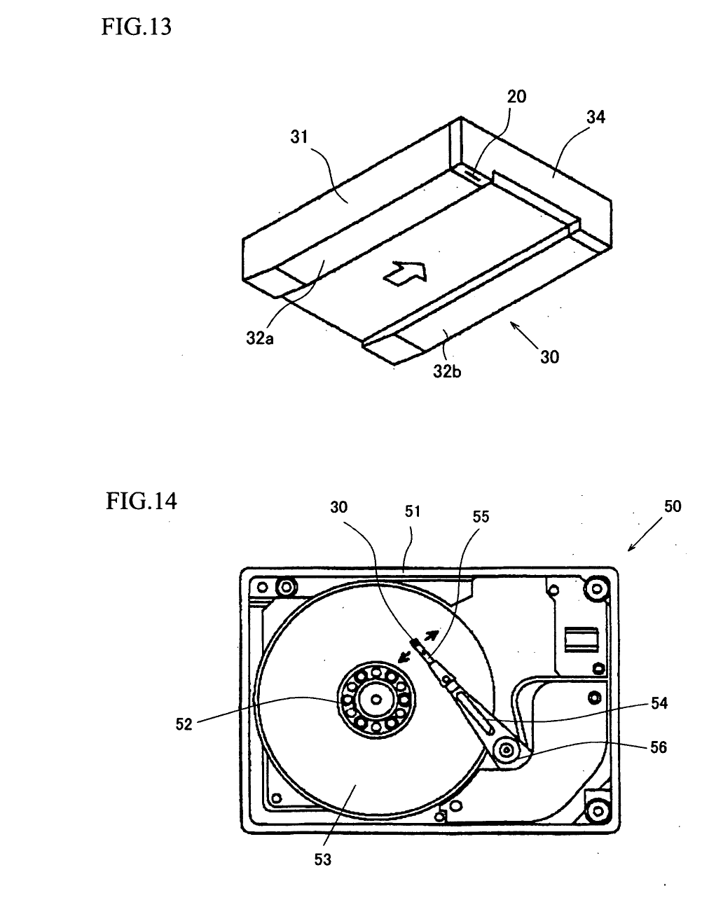

The magnetic head 20 of each of the embodiments is formed by forming the films on the substrate 4, etching the films, etc., and the magnetic head 20 is assembled in a head slider 30 shown in FIG. 13. FIG. 13 is a perspective view of the slider 30. Float rails 32a and 32b, which are formed for floating the head slider 30 from the surface of the magnetic recording disk, is formed in the air bearing surface of the head slider 30, which faces the magnetic recording disk, along edges of a slider body 31. The magnetic head 20, which includes the read-head and the write-head, is provided on the front end side of the head slider 30 (on the downstream side of an air stream) and faced the magnetic recording disk 53. The magnetic head 20 is protected by a protection film 34.

A magnetic disk drive unit, in which the head slider 30 is attached, is shown in FIG. 14. The magnetic disk drive unit 50 has a box-shaped casing 51 and a magnetic recording disk 53, which is accommodated in the casing 51 and rotated by a spindle motor 52. A carriage arm 54 is provided near by the magnetic recording disk 53 and capable of turning in parallel to the surface of the magnetic recording disk 53. A head suspension 55 is attached to a front end of the carriage arm 54 and extended therefrom. A head slider 30 is attached to a front end of the head suspension 55. The head slider 30 is attached in a face of the head suspension 55 facing the surface of the magnetic recording disk 53.

The head slider 30 is elastically pressed onto the surface of the magnetic disk 53 by the head suspension 55. Therefore, the head slider 30 contacts the surface of the magnetic disk 53 while stopping the rotation of the magnetic disk 53. When the magnetic recording disk 53 is rotated by the spindle motor 52, the head slider 30 is floated from the surface of the magnetic recording disk 53 by the air stream generated by rotation of the magnetic recording disk 53. Then, an actuator 56 performs a seeking action, so that the carriage arm 54 is turned to move to prescribed positions and the magnetic head 20 is capable of recording data in and reproducing data from the magnetic recording disk 53.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A magnetic head,
comprising:
a write-head;
a read-head having a read-element, which is grounded to a substrate via a resistance; and
an electromagnetic wave shielding layer covering over a resistance area, in which the resistance is formed.

2. The magnetic head according to claim 1,
wherein said read-head has an upper shield and a lower shield, and
a shield pattern, which acts as said electromagnetic wave shielding layer, is formed in at least one of the upper and lower shields.

3. The magnetic head according to claim 2,
wherein the resistance is provided between the lower shield and the substrate in a layering direction.

4. The magnetic head according to claim 3,
wherein the resistance is provided between the lower shield and the upper shield in the layering direction.

5. The magnetic head according to claim 1,
wherein the resistance is provided between the lower shield and the substrate in a layering direction, and
said electromagnetic wave shielding layer is separated from magnetic layers constituting said read-head and said write-head and formed between the resistance and the lower shield in the layering direction.

6. The magnetic head according to claim 1,
wherein the resistance is provided between the lower shield and the substrate in a layering direction, and
said electromagnetic wave shielding layer is separated from magnetic layers constituting said read-head and said write-head and formed between the resistance and the substrate in the layering direction.

7. The magnetic head according to claim 1,
wherein the resistance is provided between the lower shield and the upper shield in a layering direction, and
said electromagnetic wave shielding layer is separated from magnetic layers constituting said read-head and said write-head and formed on the upper side of the upper shield.

8. The magnetic head according to claim 1,
wherein the resistance is provided between the lower shield and the upper shield in a layering direction, and
said electromagnetic wave shielding layer is separated from magnetic layers constituting said read-head and said write-head and formed on the upper side of said write-head.

9. The magnetic head according to claim 1,
wherein the resistance is provided between the lower shield and the upper shield in a layering direction, and
a pair of said electromagnetic wave shielding layers are separated from magnetic layers constituting said read-head and said write-head and formed between the lower shield and the substrate and on the upper side of the upper shield.

10. The magnetic head according to claim 1,
wherein the resistance is provided between the lower shield and the upper shield in a layering direction, and
a pair of said electromagnetic wave shielding layers are separated from magnetic layers constituting said read-head and said write-head and formed between the lower shield and the substrate and on the upper side of said write-head.
